(19) United States
(12) Patent Application Publication
(10) Pub. No.: US 2014/0160591 A1
(43) Pub. Date: Jun. 12, 2014

(54) STORAGE APPARATUS AND DATA MANAGEMENT METHOD

(71) Applicants: Naoki Sakamoto, Odawara (JP); Shigeo Homma, Odawara (JP); Kosuke Komikado, Odawara (JP); Seiki Morita, Odawara (JP)

(72) Inventors: Naoki Sakamoto, Odawara (JP); Shigeo Homma, Odawara (JP); Kosuke Komikado, Odawara (JP); Seiki Morita, Odawara (JP)

(73) Assignee: Hitachi, Ltd., Tokyo (JP)

(21) Appl. No.: 13/805,586

(22) PCT Filed: Dec. 6, 2012
(86) PCT No.: PCT/JP2012/007830

§ 371 Date: Jan. 15, 2014

(51) Int. Cl. G11B 20/18

(52) U.S. Cl. CPC G11B 20/1816
USPC 360/53

(57) ABSTRACT

A storage apparatus has a first storage device in which the user data is stored and a second storage device which the management information including a primary hash value corresponding to the data management unit including a user data is stored for every data management unit. The storage apparatus (A) receives a read request, acquires a primary hash value of a first management unit which is a data management unit including read target user data from the second storage device, (B) reads data of the first management unit from the first storage device, (C) computes the primary hash value based on the data of the data management unit which is read, (D) determines whether the primary hash value in (A), and the primary hash value in (C) are in agreement, and (E) sends the read target user data to a upper level apparatus when the agreement is obtained.

### TECHNICAL FIELD

The present invention relates to error checking of the data read from a storage device.

### BACKGROUND ART

When data is stored in disc media, such as HDD (Hard Disk Drive), a storage apparatus, generally uses LA (Logical Address)/LRC (Longitudinal Redundancy Check) as error detecting code (for example, refer to PTL1). Specifically, for example, at the time of data writing, the storage apparatus adds LA/LRC to data, and transmits a set of data and the LA/LRC to HDD. Thereby, the set of data and the LA/LRC is stored in HDD. And at the time of data reading, the storage apparatus reads the set of data and the LA/LRC from HDD, and performs error checking of data using the LA/LRC.

### CITATION LIST

### Patent Literature

PTL 1: U.S. Pat. No. 5,819,054

### SUMMARY OF INVENTION

### Technical Problem

For example, although new data is transmitted to HDD from the storage controller at the time of writing in which old data of HDD is updated to new data, a case where new data is not stored in HDD by failure of HDD may happen.

In such a case, the old data remains without updated in the area of HDD to which the new data to be written. This old data is stored in HDD in sets with corresponding LA/LRC to this old data.

Therefore, in case the data of this area is read afterward, the set of old data and corresponding LA/LRC to old data is read, and a failure (henceforth non-written failure) which old data is not updated to new data, cannot be detected by using LA/LRC.

Moreover, although an application demand of cheap high-capacity drive is increasing with a data volume increase in recent years, there is a case which a cheap high-capacity drive, for example may not support the sector of size required in order to give LA/LRC to data, and there is a difficulty for using LA/LRC and also a problem that a failure rate of incidence is high.

### Solution to Problem

A storage apparatus has a first storage device in which user data is stored, a second storage device in which management information containing a primary hash value corresponding to a data management unit including user data is stored for every data management unit, and a controller which is coupled to the first and the second storage device.

The controller (A) receives a read request of the read target user data from the upper level apparatus, acquires the primary hash value of the first management unit which is the data management unit containing the read target user data from the second storage device, (B) reads the data of the first management unit from the first storage device, (C) computes the primary hash value based on the data of the first management unit, (D) determines whether the primary hash value in the (A) and the primary hash value in (C) are in agreement, and sends the read target user data contained in the first management unit to the upper level apparatus, when the primary hash value in (A) and the primary hash value in (C) are in agreement.

### Advantageous Effects of Invention

A non-written failure is detectable. Moreover, even if there is not error detecting code, a failure of read target data is detectable.

### BRIEF DESCRIPTION OF DRAWINGS

FIG. 1 is a diagram illustrating the outline of Example 1.

FIG. 2 is a diagram showing a configuration example of a storage system according to the Example 1.

FIG. 3 is a diagram showing an example of a relationship between PDEV and LDEV.

FIG. 4 is a diagram illustrating a configuration and a data flow in connection with a write command process of a storage apparatus according to Example 1.

FIG. 5 is a diagram showing an example of a configuration of a secondary hash table according to Example 1.

FIG. 6 is a diagram showing an example of a configuration of a primary hash table according to Example 1.

FIG. 7 is a diagram showing an example of a configuration of a data storing table according to Example 1.

FIG. 8 is a flow chart of a write command process according to Example 1.

FIG. 9 is a flow chart of a primary hash table consistency confirmation process according to Example 1.

FIG. 10 is a flow chart of a user data consistency confirmation process according to Example 1.

FIG. 11 is a flow chart of a physical chunk number reference number update process according to Example 1.

FIG. 12 is a diagram illustrating a configuration and a data flow in connection with a read command process of a storage apparatus according to Example 1.

FIG. 13 is a flow chart of a read command process according to Example 1.

FIG. 14 is a karnaugh map about various data and tables in a read command process.

FIG. 15 is a karnaugh map about various data and tables in a write command process.

FIG. 16 is a diagram showing a data structure of primary hash table entries according to Example 1.

FIG. 17 is a diagram showing a physical storing state of a primary hash table entry according to Example 1.

FIG. 18 is a diagram illustrating an allocation of a physical chunk number of a physical chunk which stores a primary hash table entry.

FIG. 19 is a diagram illustrating a reference of a primary hash table entry.

FIG. 20 is a diagram illustrating a reference of a primary hash table entry according to a modification.

FIG. 21 is a diagram showing a configuration example of a storage system according to Example 2.

### DESCRIPTION OF EMBODIMENTS

Some examples are described with reference to drawings. In addition, examples described below do not limit the invention according to the claims and all the elements or the combinations of those explained in the examples are not necessarily indispensable for the solution means of the invention.

In addition, although various information of the present invention may be explained using expressions such as “aaa table” etc in the following explanations, the various information may be expressed using a data structure other than a table. Therefore, in order to show that it is not dependent on the data structures, “aaa table” etc may be called “aaa information” etc.

### Example 1

First, the outline of the Example 1 is explained.

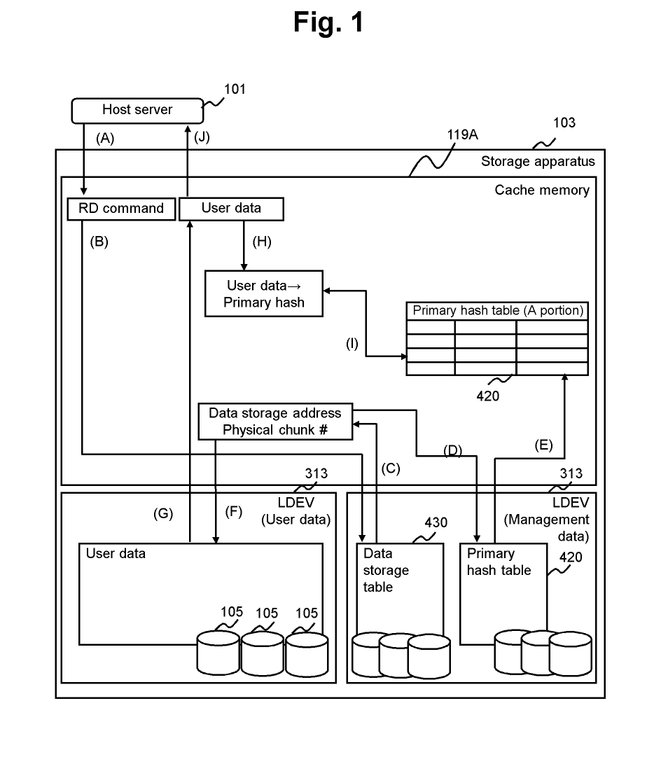

FIG. 1 is a diagram illustrating an outline of Example 1.

When the storage apparatus 103 receives a read command (RD command) from the host server (henceforth, host) 101 ((A) of FIG. 1), the storage apparatus 103 specifies the logical chunk number of the chunk in which the read target data is stored from the read destination information (for example, LUN (Logical Unit Number)/LBA (Logical Block Address)) included in the read command, and refers to a data storing table 430 using this logical chunk number ((B) of FIG. 1). Subsequently, the storage apparatus 103 acquires a physical chunk number and a data storing address of a chunk corresponding to the logical chunk number from the data storing table 430 ((C) of FIG. 1).

Subsequently, the storage apparatus 103 reads a primary hash value corresponding to the physical chunk number acquired from the primary hash table 420 in LDEV 313 to a cache memory 119A ((D),(E) of FIG. 1).

Moreover, the storage apparatus 103, reads data of a corresponding chunk from LDEV 313 to the cache memory 119A based on the physical chunk number and the data storing address of the chunk in which the read target data is stored ((F),(G) of FIG. 1).

Subsequently, the storage apparatus 103 computes a primary hash value corresponding to this chunk based on the read data of the chunk ((H) of FIG. 1). The storage apparatus 103 determines whether the primary hash value computed from the data of the chunk and the primary hash value acquired from the primary hash table 420 correspond ((I) of FIG. 1).

As a result, if the primary hash value computed from the data of the chunk and the primary hash value acquired from the primary hash table 420 correspond, it means that failure(s) (data corruption, non-written failure, etc.) have not occurred to the data of the chunk read from LDEV 313, so the storage apparatus 103 takes out the read target data in the chunk read to the cache memory 119 A and transmits the read target data to the host 101 (FIG. 1 (J)).

Next, the storage system according to Example 1 is explained in detail.

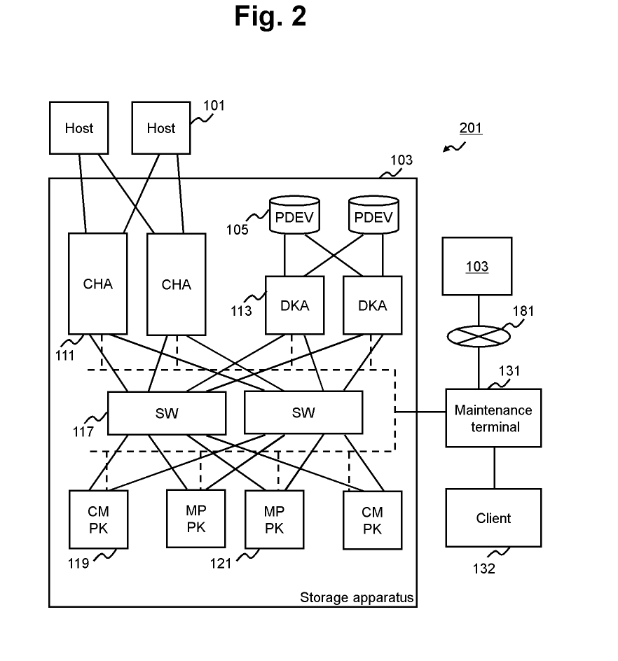

FIG. 2 is a diagram showing the configuration example of the storage system according to Example 1.

The storage system 201 has one or more storage apparatus 103 and a maintenance terminal 131 coupled to one or more storage apparatus 103. The maintenance terminal 131 is coupled to one or more storage apparatus 103 via the communication network 181, for example. The maintenance terminal 131 may exist for every storage apparatus 103. The maintenance terminal 131 communicates with a client 132. The client 132 is one or more computer, and has a man machine interface device (a display device and an input device as an example) as an I/O device, for example.

The storage apparatus 103 has one or more PDEV 105, and a controller coupled to one or more PDEV 105, for example. The controller, for example has a back end I/F (communication interface device) coupled to one or more PDEV 105, a front end I/F coupled to the host 101, a storage recourse, and one or more MPPK (microprocessor package) 121 that are coupled to those elements. According to the configuration example shown in FIG. 2, the back end I/F is one or more DKA (disk adapter) 113, and the front end I/F is one or more CHA (channel adapter) 111, and the storage recourse is one or more CMPK (cache memory package) 119. The CHA 111, the DKA 113, the CMPK 119, and the MPPK 121 are coupled to one or more SW (switching equipment) 117. Although multiple CHAs 111, DKAs 113, MPPKs 121, CMPKs 119, and SWs 117 exist from a viewpoint of redundancy, respectively, regardless of 2 shown in the diagram, the number of at least one element among them may be equal to or larger/less than 2.

The PDEV 105 is a physical storage device (for example, a hard disk drive or a flash memory) which stores user data. The user data is data which the host 101 stores in the storage apparatus 103. In this example, the user data is managed considering the chunk which is a certain size as a unit. The size of the chunk may be as arbitrary sizes, such as 512 B, 4 KB, 1 MB, and 1 GB, for example.

The CHA 111, receives an I/O command (a write command (a write request) or a read command (a read request)) which has I/O destination information (read destination information or write destination information) from the host 101, and forwards the received I/O command to one of the multiple MPPKs 121. The I/O destination information, for example includes a logical volume ID (for example, LUN (Logical Unit Number)) and an area address (for example, LBA (Logical Block Address)) on the logical volume.

The DKA 113 reads data from the PDEV 105, and writes the data in the cache memory (CM) in the CMPK 119, and the DKA 113 reads data from the cache memory in the CMPK119, and writes the data in the PDEV (for example, a PDEV which is a basis of logical volume of write destination of data) 105.

The MPPK121 is a device which has multiple MP(s) (microprocessor: henceforth, the processor). The processor processes the I/O command from the CHA 111.

Each element of the CHA 111, the DKA 113, the CMPK 119, and the MPPK 121 can communicate with other elements of the CHA 111, the DKA 113, the CMPK 119, and the MPPK 121 through the SW 117.

The CMPK 119 contains one or more cache memory. One or more cache memory is a volatile memory, such as DRAM, for example. In addition, generally the cache memory of the CMPK 119 has a small capacity compared with the PDEV 105. One or more cache memory may have a storage area (henceforth, a shared area) which stores management information which the processor refers to, other than a storage area (henceforth, a cache area) which stores temporarily the data which is outputted/inputted from/to the PDEV 105. Here, reading data from the PDEV 105 to the cache memory is called staging, and writing data in the PDEV 105 from the cache memory is called destage.

Maintenance terminal 131 can communicate with the MPPK 121 at least out of the CHA 111, the DKA 113, the CMPK 119, and the MPPK 121. The maintenance terminal 131 can collect information from the CHA 111, the DKA 113, the CMPK 119, and the MPPK 121, and can store the collected information, for example. Moreover, the maintenance terminal 131 can send a request according to the directions from the client 132 to the MPPK 121 of the storage apparatus 103.

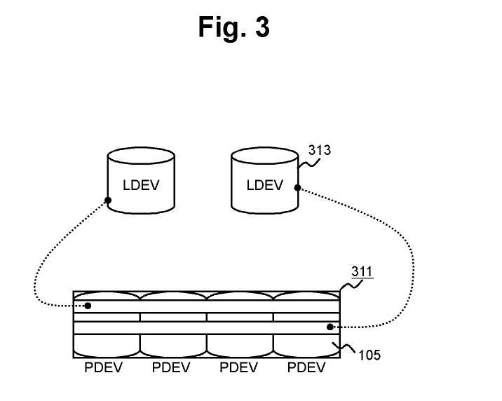

FIG. 3 is a diagram showing an example of a relationship between PDEV and LDEV.

A RAID (Redundant Array of Independent (or Inexpensive) Disks) group 311 is configured by multiple PDEVs 105. This RAID group 311 is a RAID group of the RAID level from which the redundancy of data is secured. That is, even if there is a case where a failure occurs in the PDEV 105 below a predetermined number, a desired data can be acquired based on the data of the PDEV(s) 105 in which failure has not occurred. Here, based on the data of the PDEV(s) 105 in which a failure has not occurred, acquiring (creating) a desired data is called a collection read.

Based on the storage area of the RAID group 311, A LDEV 313 which are one or more logical storage device is formed. One logical volume may be one LDEV 313 or may be the LDEV group with which multiple LDEVs 313 are coupled.

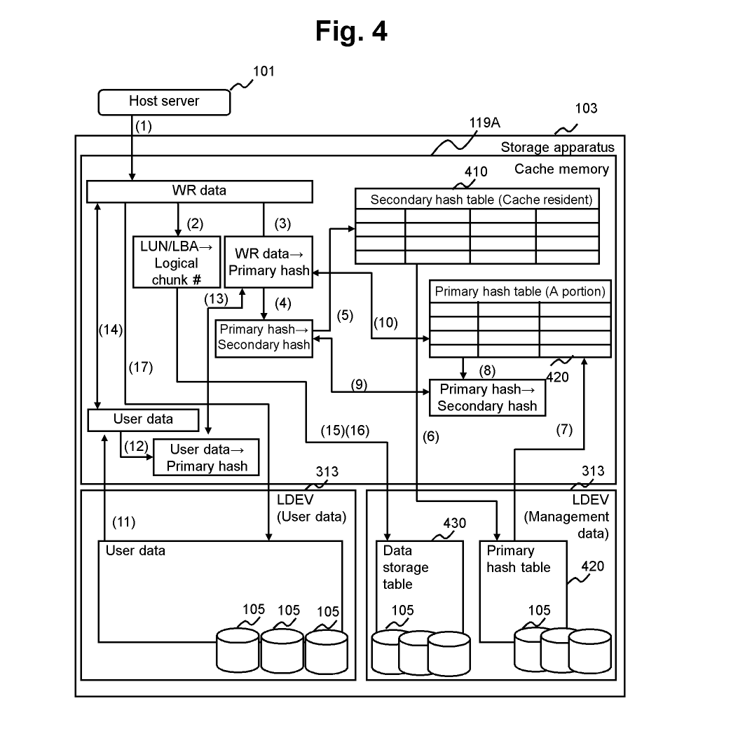

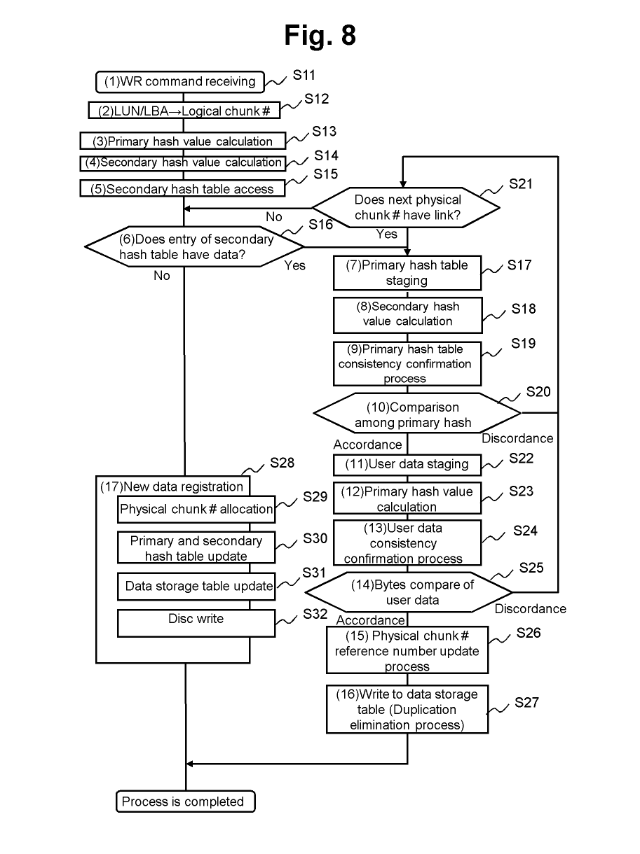

FIG. 4 is a diagram illustrating a configuration and data flow in connection with the write command process of the storage apparatus according to Example 1. In addition, the data flow (1) through (17) shown in FIG. 4 is mentioned later with an explanation of the flow chart in FIG. 8 through 10.

The cache memory 119 A of the CMPK 119 stores a secondary hash table 410 and a part of a primary hash table 420.

The primary hash table 420 manages a hash value (primary hash value) computed by predetermined hash algorithm based on the data of each chunk. Here, the hash algorithm which computes the primary hash value from the data of the chunk, and the length of the primary hash value are arbitrary. Here, the chunk which has the same data has the same hash value, so the group of chunks having the same hash value is the group of chunks which may have the same data. In addition, when the length of the primary hash value is short, chunks which have the same hash value increase, and chunks which become the target to compare each bit on a deduplication process mentioned later increase, and the throughput increases. For this reason, it is necessary to make the size of the primary hash value into certain sizes, such as 20 Bytes, 32 Bytes, and 64 Bytes, for example. The capacity of the primary hash table 420 which manages the primary hash value for each chunk, becomes a large scale comparatively, so the primary hash table 320 is stored in the LDEV 313, and the partial entries of the primary hash table 420 are read to the cache memory 119A in this example.

The secondary hash table 410 is a table in which a hash value (secondary hash value) computed based on the primary hash value is used as an index, and is a table for accessing the primary hash value efficiently corresponding to the secondary hash value. Here, a hash algorithm for computing the secondary hash value from the primary hash value, and the length of the secondary hash value are arbitrary. In this example, the secondary hash value is comparatively a short size (for example, 2 Bytes, 4 Bytes) compared with the primary hash value. In this example, the whole secondary hash table 410 is managed to reside in the cache memory 119A.

In this example, the LDEV 313 which stores user data, and the LDEV 313 which stores the management data (management information) of the primary hash table 420, etc, are the LDEV configured by the RAID group of another PDEV 105. The LDEV 313 which manages management data stores the primary hash table 420 and the data storing table 430. In addition, the primary hash table 420 and the data storing table 430 may be stored in another LDEV 313.

The data storing table 430 is a table which manages the data storing address of the LDEV 313 in which the data of the chunk is stored. The data storing table 430 is a table in which the logical chunk # of a chunk (logiccal chunk #) is used as an index. In this embodiment, regarding the chunks which store the same data, assigning the same data storing address prevents the data from overlapping and stored in the LDEV 313. In addition, since the data storing table 430 needs to store the entries for logical chunks and becomes a large scale comparatively, it is stored in the LDEV 313 in this example.

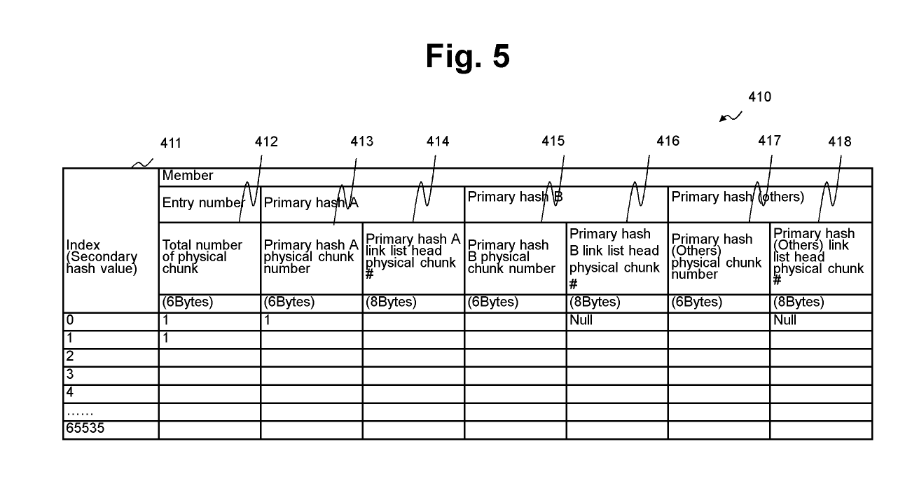

FIG. 5 is a diagram showing an example of a configuration of the secondary hash table according to Example 1.

The secondary hash table 410 stores an entry (secondary hash table entry) which includes fields of a index 411, a entry number 412, a primary hash A physical chunk number 413, a primary hash A link list head physical chunk number 414, a primary hash B physical chunk number 415, a primary hash B link list head physical chunk number 416, a primary hash (others) physical chunk number 417, and a primary hash (others) link list head physical chunk number 418.

A secondary hash value computed based on a primary hash value is stored in the index 411. A total number of the physical chunks corresponding to the primary hash value by which the secondary hash value of the index 411 is computed is stored in the entry number 412. A number of the physical chunks corresponding to a certain primary hash value (it is considered as the primary hash A) by which the secondary hash value of the index 411 is computed is stored in the primary hash A physical chunk number 413. In addition, the primary hash A is a different primary hash value for every entry. A physical chunk number of the entry corresponding to the chunk of the head of the link list (primary hash A link list) which consists of the entries of the primary hash table 420 corresponding to the multiple chunks corresponding to the primary hash A is stored in the primary hash A link list head physical chunk number 414. A number of the physical chunks corresponding to a certain different primary hash value (it is considered as the primary hash B) from the primary hash A by which the secondary hash value of the index 411 is computed is stored in the primary hash B physical chunk number 415. In addition, the primary hash B is a different primary hash value for every entry. A physical chunk number of the entry corresponding to the chunk of the head of the link list (primary hash B link list) which consists of entries corresponding to the multiple chunks corresponding to the primary hash B is stored in the primary hash B link list head physical chunk number 416. A number of the physical chunks corresponding to one or more different primary hash value (it is considered as primary hash (others)) from the primary hash A and the primary hash B by which the secondary hash value of the index 411 is computed is stored in the primary hash (others) physical chunk number 417. In addition, the primary hash (others) is a different primary hash value for every entry. A physical chunk number corresponding to the entry of the chunk of the head of the link list which consists of entries of the multiple chunks corresponding to the primary hash (others) is stored in the primary hash (others) link list head physical chunk number 418. In this example, one entry is divided into three, the primary hash A, the primary hash B, and other primary hash value, and the fields corresponding to those are prepared, so even if there is a case where a primary hash value being as the same secondary hash value becomes three or more, the prepared fields can respond appropriately. Thereby, capacity required for the secondary hash table 410 can be reduced.

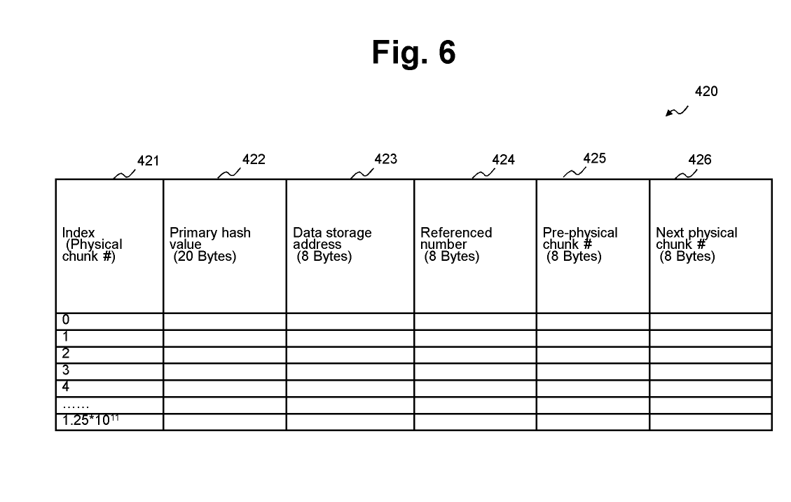

FIG. 6 is a diagram showing an example of a configuration of the primary hash table according to Example 1.

The primary hash table 420 is a table which manages the hash value (primary hash value) computed by the predetermined hash algorithm based on the data of the chunk including the user data. The primary hash table 420 stores an entry (primary hash table entry: management element) including fields of a index 421, a primary hash value 422, a data storing address 423, a referenced number 424, a pre-physical chunk number (#) 425, and a next physical chunk number (#) 426.

A number (physical chunk number) of a physical chunk is stored in the index 421. A primary hash value computed based on the data of the chunk of the physical chunk number of the index 421 is stored in the primary hash value 422. An address (data storing address) of the LDEV 313 in which the data of the chunk corresponding to the physical chunk number of the index 421 is stored in the data storing address 423. A number of the logical chunks (namely, the logical chunks which store the same data) which is referring to the data of the physical chunk of the physical chunk number is stored in the referenced number 424. A number of the physical chunk which is a physical chunk used as the same primary hash value, and serves as a turn in front of the link list is stored in the pre-physical chunk number 425. A number of the physical chunk which is a physical chunk used as the same primary hash value, and serves as the next turn of the link list is stored in the next physical chunk number 426.

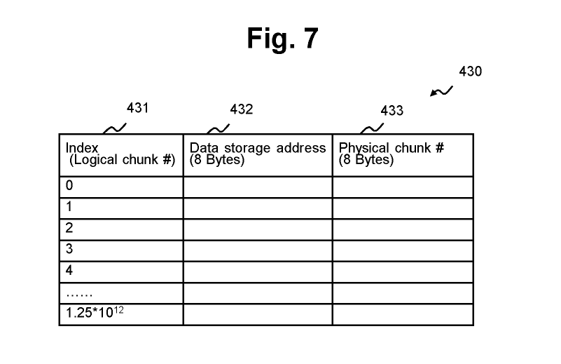

FIG. 7 is a diagram showing an example of the configuration of the data storing table according to Example 1.

The data storing table 430 stores an entry (data storing table entry) including fields of an index 431, a data storing address 432, and a physical chunk number (#) 433.

A number (logical chunk number) of the logical chunk is stored in the index 431. A data storing address in which the data of the chunk corresponding to the logical chunk number of the index 431 is stored, is stored in the data storing address 432. Aphysical chunk number of the chunk corresponding to the logical chunk number of the index 431 is stored in the physical chunk number 433. In this data storing table 430, the logical chunk number of a different logical chunk which stores the same data is associated with the same physical chunk number, and is managed.

An example of implementation of the storage apparatus 103 is given here, and the size etc, of the primary hash table 420, the secondary hash table 410, and the data storing table 430 shown in FIG. 5 through FIG. 7 are explained.

On the storage apparatus 103, the size of the chunk is set to 8 KB, size of the primary hash value is set to 20 Bytes, and the secondary hash size is set to 2 Bytes, and the data storing address is set to 8 Bytes. Here, when the total capacity of the actual physical storage device of the storage apparatus 103 is set to 1 PB, the number of the physical chunks is 1.25×10¹¹. Moreover, when the logical total capacity at the time of expecting the deduplication of the chunk is set to 10 PB, the number of logical chunks is 1.25×10¹².

In this case, the size of the secondary hash table 410 is 48 Bytes (size of one entry)×65536=3 MB, and is a size storable in the cache memory 119A. On the other hand, the primary hash table 420 is 56 Bytes (size of one entry)×1.25×10¹¹=7 TB, and is a size which is too large for storing in the cache memory 119A in this example. Moreover, the data storing table 430 is 18 Bytes (size of one entry)×1.25×10¹²=20 TB, and in order to make it store in the cache memory 119A, it is too large size. Then, in this example, the primary hash table 420 and the data storing table 430 are stored in the LDEV 313 as described above.

Next, an operation by the storage apparatus 103 according to Example 1 is explained.

First, the write command process at the time of receiving a write command (WR command) from the host 101 is explained with reference to FIG. 4 and FIG. 8 through 11. In addition, the mark (1) through (17) in FIG. 8 through 11 corresponds to the mark (1) through (17) in FIG. 4.

FIG. 8 is a flow chart of the write command process according to Example 1.

(Step S11) The processor of the MPPK 121 of the storage apparatus 103 receives a write command from the host 101 ((1) of FIG. 4). Here, the I/O destination information (for example, LUN and LBA) for data and write target data (write target user data) are included in the write command. In this example, the size of the write target data is explained as the chunk size.

(Step S12) The processor computes a logical chunk number corresponding from the I/O destination information ((2) of FIG. 4).

(Step S13) The processor computes a primary hash value based on the write target data, and stores it in the cache memory 119A ((3) of FIG. 4).

(Step S14) The processor computes a secondary hash value from the computed primary hash value ((4) of FIG. 4).

(Step S15) The processor makes the computed secondary hash value as an index, acquires the entry (process target entry) corresponding to the index with reference to the secondary hash table 410 ((5) of FIG. 4). Here, since the same primary hash value is set to be searched using secondary hash value, a search for the primary hash value can be done easily and quickly.

(Step S16) The processor determines whether an unsettled physical chunk number which is not performing the following process is stored or not in the acquired entry. When the unsettled physical chunk number is not associated (Step S16: No), the processor advances the process to the Step S28. On the other hand when the unsettled physical chunk number is associated (Step S16: Yes), the processor acquires the physical chunk number (for example, physical chunk number, etc of the primary hash A link list head physical address number 414) of the entry and requires an entry corresponding to the physical chunk number of the primary hash table 420 ((6) of FIG. 4), and advances the process to the Step S17. In addition, the process of Steps S16-S25 is performed until the chunk with which data overlaps is detected or the process for all the primary hash values which are registered in the process target entry of the secondary hash table 410 is completed.

(Step S17) The processor acquires an entry of the primary hash table 420 corresponding to the required physical chunk number. In addition, when the entry is not in the cache memory 119A, staging of the one or more entries (chunk) including the entry of the primary hash table 420 corresponding to the physical chunk number required from the LDEV 313 is carried out ((7) of FIG. 4).

(Step S18) The processor computes a secondary hash value from the primary hash value of the primary hash value 422 of the entry corresponding to the physical chunk number acquired in (7) (FIG. 4 (8)).

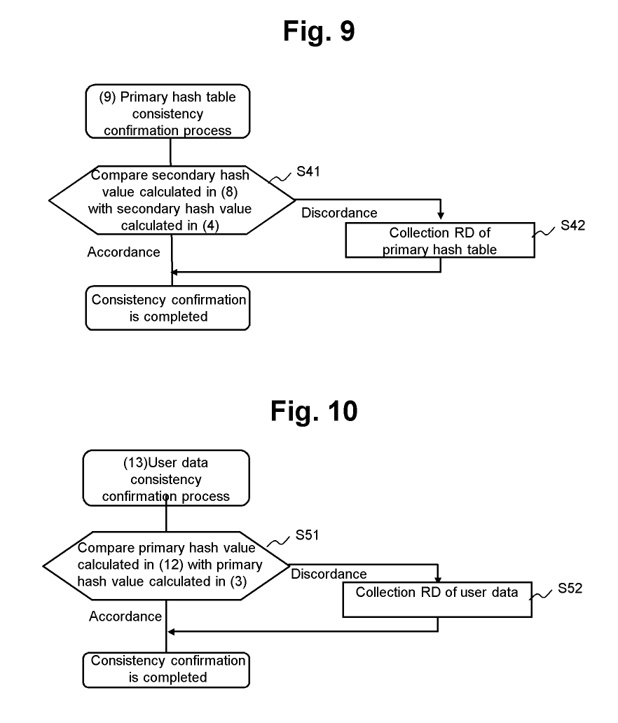

(Step S19) The processor performs a primary hash table consistency confirmation process (refer to FIG. 9) ((9) of FIG. 4). According to this primary hash table consistency confirmation process, the entry of the primary hash table 420 with consistency is acquirable.

(Step S20) The processor compares the primary hash value which is computed in (3), with the primary hash value of the primary hash value 422 of the entry of the primary hash table 420 with consistency ((10) of FIG. 4), and when these primary hash values correspond (Step S20: accordance), it means the data of the chunk corresponding to this entry of the primary hash table 420 may be the same as the write target data, so the processor advances the process to the Step S22. On the other hand, when these primary hash values are not in agreement (Step S20: discordance), the processor advances the process to the Step S21. Thus, since the chunk which may be the same data as the write target data is detected using the primary hash value, it is not necessary to compare by bit unit about all the data and the throughput can be reduced.

(Step S21) The processor determines whether the physical chunk number is stored in the next physical chunk number 426 of the process target entry of the primary hash table 420, and when the physical chunk number is stored (Step S21: Yes), the processor performs the process after the Step S17 about the physical chunk number, and when the physical chunk number is not stored (Step S21: No), it advances the process to the Step S16.

(Step S22) The processor acquires a data storing destination address from the data storing address 423 of the process target entry of the primary hash table 420, and acquires user data stored at the data storing destination address. In addition, when the data corresponding to this data storing destination address is not stored in the cache memory 119A, staging of the data (user data) of the data storing destination address of the LDEV 313 is carried out (FIG. 4 (11)).

(Step S23) The processor computes a primary hash value from the user data acquired in (11) ((12) of FIG. 4).

(Step S24) The processor performs a user data consistency confirmation process (refer to FIG. 10) ((13) of FIG. 4). According to this user data consistency confirmation process, the user data with consistency is acquirable.

(Step S25) The processor compares each byte of the write target data with the user data with consistency acquired in the Step 24, and determines whether these data correspond or not ((14) of FIG. 4). As a result, when the write target data and the acquired user data are in agreement (Step S25: accordance), the processor advances process to the Step S26, in order to eliminate a duplication of the same data. On the other hand, when the write target data and the acquired user data are not in agreement (Step S25: discordance), the processor advances the process to the Step S21.

(Step S26) The processor performs a physical chunk number reference number update process (refer to FIG. 10) to updates the primary hash table 420 (FIG. 4 (15)).

(Step S27) The processor performs the deduplication process (FIG. 4 (16)). That is, the processor writes the data storing address and the physical chunk number about the user data which are acquired in (11) in the entry of the data storing table 430 corresponding to the logical chunk number computed in (2), and ends the process.

(Step S28) The processor performs the process (Steps S29 through S32) which registers the write target data newly ((17) of FIG. 4), and ends the process.

(Step S29) The processor secures a physical chunk assigned to the logical chunk of the write target data. That is, the processor determines the physical chunk number of the physical chunk to assign.

(Step S30) The processor updates the primary hash table 420 and the secondary hash table 410. Specifically, on the entry corresponding to the physical chunk number of the physical chunk to which the primary hash table 420 is assigned, the processor stores the primary hash value of the write target data in the primary hash value 422, and stores the data storing address of the physical chunk assigned to the data storing address 423, and stores 1 in the referenced number 424. Moreover, on the entry of the secondary hash table 410 corresponding to the secondary hash value corresponding to the primary hash value of the write target data, the processor stores the physical chunk number of this write target data in the head physical chunk number of the next link list of the link list managed in the entry. For example, when the primary hash A link list head physical chunk number 414 of the entry of the secondary hash table 410 is Null, the processor stores the physical chunk number of the write target data there. Moreover, when the primary hash A link list head physical chunk number 414 of the entry of the secondary hash table 410 is not Null, and the primary hash B link list head physical chunk number 416 is Null, the processor stores the physical chunk number of the write target data in the primary hash B link list head physical chunk number 416.

(Step S31) The processor updates the data storing table 430. Specifically, the processor stores the data storing address of the write target data in the data storing address 432 on the entry corresponding to the logical chunk number of the write target data of the data storing table 430, and stores the physical chunk number of the physical chunk assigned to the physical chunk number 433.

(Step S32) The processor stores the write target data in the storage destination of the LDEV 313 which the data storing address of the assigned physical chunk shows. Here, since the LDEV 313 in which the primary hash table 420 is written differs from the LDEV 313 in which the write target data is written, there is almost no possibility that a failure of which neither a writing of the primary hash table 420 in the LDEV 313 nor a writing of the write target data in the LDEV 313 is performed, that is, a non-written failure in both sides occurs. Therefore, even if there is a case where a non-written failure occurs to one side, about the other side, the probability which a non-written failure has not occurred is very high.

Therefore, in the case where a non-written failure occurs only in one side, the primary hash value computed based on the write target data differs from the corresponding primary hash value stored in the primary hash table 420, it is detectable that a failure has occurred. In addition, also about the case where a data corruption occurs, the primary hash value computed based on the write target data differs from the corresponding primary hash value stored in the primary hash table 420, it is detectable that a failure has occurred.

FIG. 9 is a flow chart of the primary hash table consistency confirmation process according to Example 1.

The primary hash table consistency confirmation process corresponds to the process of the Step S19 ((9) of FIG. 4) of FIG. 8.

(Step S41) The processor compares the secondary hash value computed in (8) with the secondary hash value computed in (4). As a result, when both sides are in agreement (Step S41: accordance), it is thought that a failure has not occurred in the entry of the acquired primary hash table 420, so the processor ends the process. On the other hand, when both sides are not in agreement (Step S41: discordance), it is thought that a failure (data corruption, non-written failure) has occurred in the entry of the primary hash table 420, the processor advances the process to the Step S42.

(Step S42) The processor performs a collection read about the data including the entry of the primary hash table 420 acquired in (7). Therefore, data without failure is acquirable.

According to this primary hash table consistency confirmation process, an entry of the primary hash table 420 with consistency is acquirable.

FIG. 10 is a flow chart of the user data consistency confirmation process according to Example 1.

The user data consistency confirmation process corresponds to the process of the Step S24 ((13) of FIG. 4) of FIG. 8.

(Step S51) The processor compares the primary hash value computed in (12) with the primary hash value computed in (3). As a result, when both sides are in agreement (Step S51: accordance), it is thought that a failure has not occurred to the acquired user data, so the processor ends the process. On the other hand, when both sides are not in agreement (Step S51: discordance), it is thought that a failure (data corruption, non-written failure, etc.) has occurred to the user data, so the processor advances the process to the Step S52.

(Step S52) The processor performs a collection read about the user data. Therefore, user data without failure is acquirable.

According to this user data consistency confirmation process, user data with consistency is acquirable.

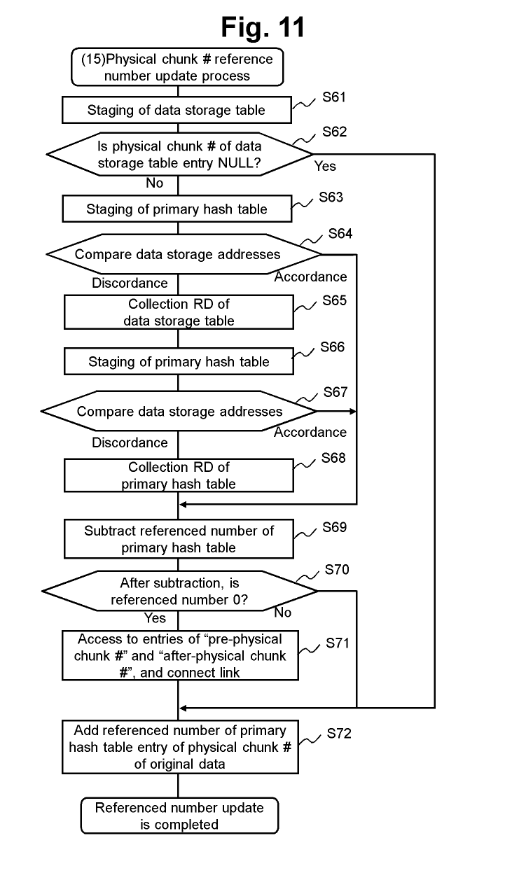

FIG. 11 is a flow chart of the physical chunk number reference number update process according to Example 1.

The physical chunk number reference number update process corresponds to the process of the Step S26 ((15) of FIG. 4) of FIG. 8.

(Step S61) The processor acquires an entry of the data storing table 430 corresponding to the logical chunk number computed in (2). Here, when the entry corresponding to the cache memory 119A does not exist, the processor carries out staging of the entry of the corresponding data storing table 430.

(Step S62) The processor determines whether the physical chunk number 433 of the acquired entry is NULL or not. As a result, when the physical chunk number 433 is NULL (Step S62: Yes), the processor advances process to the Step S72, and on the other hand, when the physical chunk number 433 is not NULL (Step S62: No), it advances the process to the Step S63.

(Step S63) The processor carries out staging of the entry of the primary hash table 420 corresponding to the physical chunk number of the physical chunk number 433.

(Step S64) The processor compares the data storing address of the entry of the data storing table 430 acquired in the Step S61 with the data storing address of the entry of the primary hash table 420 acquired in the Step S63. As a result, when the data storing addresses are in agreement (Step S64: accordance), it is thought that a data corruption has not occurred in the entry of the data storing table 430 and the primary hash table 420, so the processor advances the process to the Step S69. On the other hand, when the data storing addresses are not in agreement (Step S64: discordance), a data corruption may have occurred in the entry of the data storing table 430, so the processor advances the process to Step S65.

(Step S65) The processor performs a collection read about the corresponding entry of the data storing table 430. As a result, if there is a case where a data corruption occurs in the entry of the data storing table 430, the data in which the data corruption is canceled is obtained.

(Step S66) The processor carries out staging of the entry of the primary hash table 420 corresponding to the physical chunk number of the physical chunk number 433 of the entry of the data storing table 430 read in the Step S65.

(Step S67) The processor compares the data storing address of the entry of the data storing table 430 read in the Step S65 with the data storing address of the entry of the primary hash table 420 acquired in the Step S66. As a result, when the data storing addresses are in agreement with each (Step S67: accordance), it is thought that the data corruption has not occurred in the entry of the data storing table 430, so the processor advances the process to the Step S69. On the other hand, when the data storing addresses are not in agreement with each (Step S67: discordance), it is thought that a data corruption has occurred in the entry of the primary hash table 420, so the processor advances the process to the Step S68.

(Step S68) The processor performs a collection read about the corresponding entry of the primary hash table 420. As a result, the entry of the primary hash table 420 without a data corruption is acquirable.

(Step S69) The processor subtracts 1 from the referenced number of the referenced number 424 of the entry of the primary hash table 420.

(Step S70) The processor determines whether the referenced number of the referenced number 424 of this entry is 0 or not. As a result, when the referenced number of the referenced number 424 of the entry is 0 (Step S70: Yes), the processor advances the process to the Step S71. On the other hand, when the stored number of the referenced number 424 of the entry is not 0 (Step S70: No), the processor advances the process to the Step S72.

(Step S71) The processor performs a process to delete from the link list which the target entry is managed. Specifically, the processor couples the entry of the primary hash table 420 corresponding to the physical chunk number of the pre-physical chunk number 425 of the target entry to the entry of the primary hash table 420 corresponding to the physical chunk number of the next physical chunk number 426 of the target entry. That is, the processor stores the physical chunk number of the next physical chunk number 426 of the target entry in the next physical chunk number 426 of the entry corresponding to the physical chunk number of the pre-physical chunk number 425 of the target entry, and stores the physical chunk number of the pre-physical chunk number 425 of the target entry in the pre-physical chunk number of the entry corresponding to the physical chunk number of the next physical chunk number of the target entry.

(Step S72) The processor adds 1 to the referenced number of the referenced number 424 of the entry of the primary hash table 420 corresponding to the physical chunk number of the physical chunk of the user data determined as in agreement in (14), and ends the process.

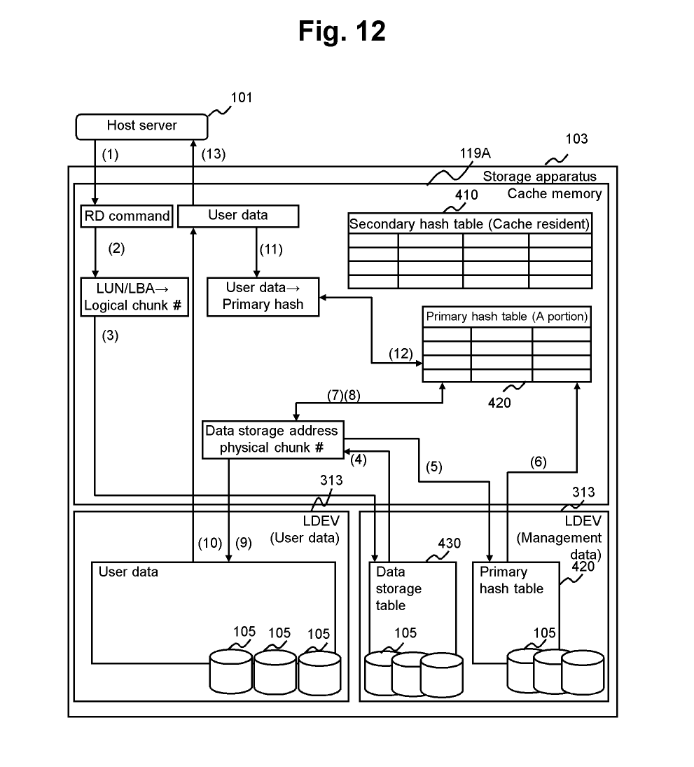

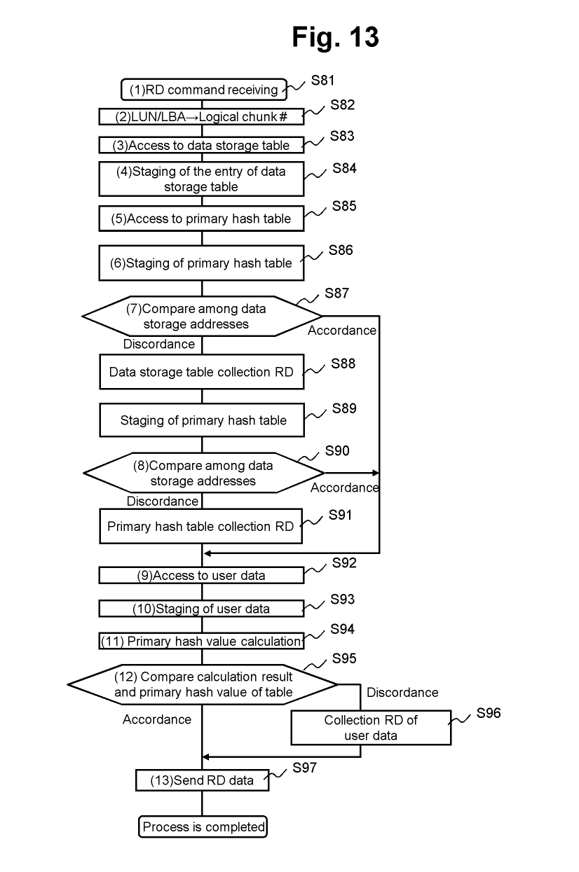

Next, the read command process at the time of receiving a read command (RD command) from the host 101 is explained with reference to FIG. 12 and FIG. 13. In addition, the mark (1) through (13) in FIG. 13 corresponds to the mark (1) through (13) in FIG. 12.

FIG. 12 is a diagram explaining the configuration and data flow in connection with the read command process of the storage apparatus according to Example 1. FIG. 13 is a flow chart of the read command process according to Example 1.

(Step S81) The processor of the MPPK 121 of the storage apparatus 103 receives a read command from the host 101 ((1) of FIG. 12). Here, the I/O destination information (for example, LUN, LBA) of data and the data length of read target data are included in the read command.

(Step S82) The processor computes a logical chunk number corresponding from the I/O destination information ((2) of FIG. 12).

(Step S83) Based on the computed logical chunk number, the processor accesses the data storing table 430, in order to acquire an entry corresponding to this logical chunk number ((3) of FIG. 12).

(Step S84) The processor carries out staging of the entry of the data storing table 430 obtained by the access of the Step S83 ((4) of FIG. 12).

(Step S85) The processor accesses the primary hash table 420, in order to acquire a corresponding entry using the physical chunk number of the physical chunk number 433 of the entry of the data storing table 430 corresponding to the logical chunk number computed in (2) ((5) of FIG. 12).

(Step S86) The processor carries out staging of the entry of the primary hash table 420 obtained by the access of the Step S85 ((6) of FIG. 12).

(Step S87) The processor compares the data storing address of the entry of the data storing table 430 staged in the Step S84 with the data storing address of the entry of the primary hash table 420 staged in the Step S86 ((7) of FIG. 12). As a result, when the data storing addresses are in agreement (Step S87: accordance), it is thought that the data corruption has not occurred in the entry of the data storing table 430, so the processor advances the process to the Step S92. On the other hand, when the data storing addresses are not in agreement with each (Step S87: discordance), there is a possibility that the data corruption may have occurred in the entry of the data storing table 430, so the processor advances the process to the Step S88.

(Step S88) The processor performs a collection read about the corresponding entry of the data storing table 430 corresponds. As a result, if there is a case where a data corruption has occurred in the entry of the data storing table 430, the entry that the data corruption is canceled is obtained.

(Step S89) The processor carries out staging of the entry of the primary hash table 420 corresponding to the physical chunk number of the physical chunk number 433 of the entry of the data storing table 430 acquired in the Step S88.

(Step S90) The processor compares the data storing address of the entry of the data storing table 430 acquired in the Step S88 with the data storing address of the entry of the primary hash table 420 acquired in the Step S89 ((8) of FIG. 12). As a result, when the data storing addresses are in agreement (Step S90: accordance), it is thought that the data corruption has not occurred in the entry of the data storing table 430, so the processor advances the process to the Step S92. On the other hand, when data storing addresses are not in agreement (Step S90: discordance), it is thought that the data corruption has occurred for the entry of the primary hash table 420, so the processor advances the process to the Step S91.

(Step S91) The processor performs a collection read about the corresponding entry of the primary hash table 420. As a result, the entry of the primary hash table 420 without a data corruption is acquirable. Therefore, the data storing address of this entry is in agreement with the data storing address of the entry of the data storing table 430 acquired in the Step S88.

By the process of the above step S86 through Step S91, the entry of the primary hash table 420 with consistency and the entry of the corresponding data storing table 430 are acquirable.

(Step S92) At the Step S86 through Step S91, by using the data storing address with consistency, the processor accesses the LDEV 313 in order to acquire the chunk including the user data (read target data) of the read target ((9) of FIG. 12).

(Step S93) The processor carries out staging of the chunk including the read target data obtained by the access of the Step S92 ((10) of FIG. 12). In this process, when the read target data is smaller than a chunk, staging of the data of the whole chunk including the read target data is carried out.

(Step S94) The processor computes a primary hash value based on the chunk including the read target data which is staged ((11) of FIG. 12).

(Step S95) The processor compares the computed primary hash value with the primary hash value of the entry of the primary hash table 420 with consistency ((12) of FIG. 12). As a result, when both primary hash value are in agreement (Step S95: accordance), it is thought that a failure has not occurred to the read target data which is staged, so the processor advances the process to the Step S97. On the other hand, when both primary hash values are not in agreement (Step S95: discordance), a data corruption may have occurred, so the processor advances the process to the Step S96.

(Step S96) The processor carries out a collection read of the chunk including the read target data. Thereby, a read target data without a data corruption is acquirable.

(Step S97) The processor sends the read target data of which a data corruption has not occurred to the host 101 of the sending source of the read command ((13) of FIG. 12). Thereby, a suitable read target data can be sent to the host 101.

Next, the confirmation opportunity of a failure occurrence on the user data, the data storing table 430 and the primary hash table 420, and the recovery process from the occurred failure are explained.

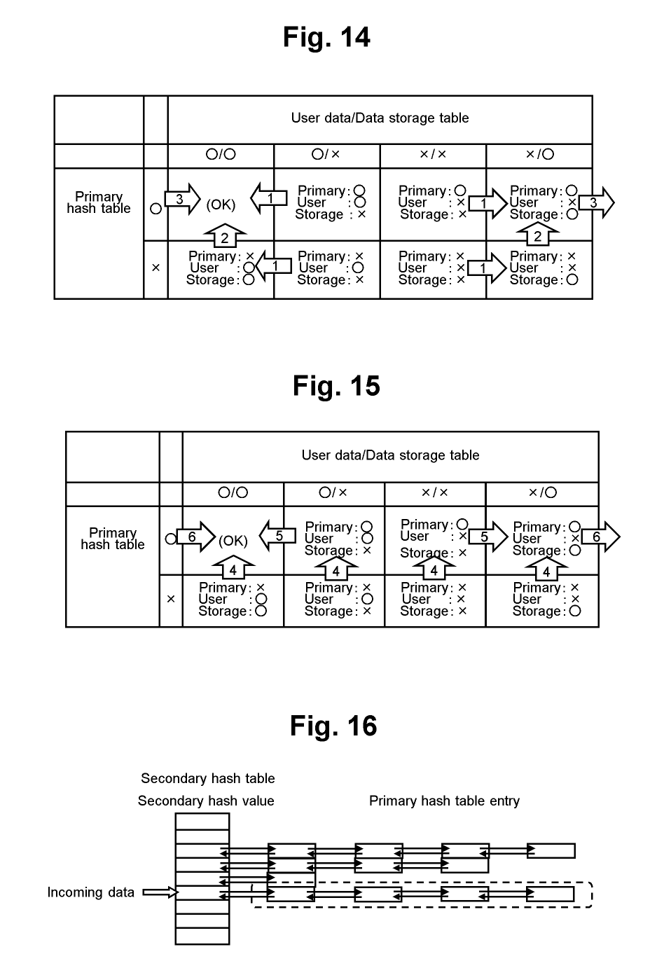

FIG. 14 is a karnaugh map about the various data and tables on the read command process. In addition, O in the figure shows normal and x shows that a failure has occurred. Moreover, in the figure, there is a portion to display “user” for the user data, “storing” for the data storing table and “primary” for the primary hash table as abbreviated.

On the read command process, the confirmation of whether a failure has occurred on the data storing table 430 or not is performed in the Step S87 ((7) of FIG. 12) of FIG. 13. Specifically, by comparing the data storing address of the entry of the staged data storing table 430 with the data storing address of the entry of the corresponding staged primary hash table 420 and determining whether they are in agreement or not, whether a failure (data corruption) has occurred or not is confirmed.

And when the data storing addresses are not in agreement, that is, when a data corruption may have occurred in the entry of the data storing table 430, an entry without a data corruption is acquired by performing a collection read about this entry. As a result, when a failure has occurred on the data storing table 430, the entry of the data storing table 430 transitions to the normal state, as shown in the arrow 1 of FIG. 14,

In the read command process, the confirmation of whether a failure has occurred in the primary hash table 420 or not, is performed in the Step S90 ((8) of FIG. 12) of FIG. 13. Specifically, comparing the data storing address of the entry of the data storing table 430 already secured in the normal state with the data storing address of the entry of the primary hash table 420 corresponding to this, and determining whether these are in agreement or not, whether a failure has occurred or not is confirmed.

And when the data storing addresses are not in agreement, that is, when a data corruption has occurred in the entry of the primary hash table 420, an entry without a data corruption is acquired by performing the collection read about this entry. As a result, when a failure has occurred on the entry of the primary hash table 420, the entry of the primary hash table 420 transitions to the normal state, as shown in the arrow 2 of FIG. 14.

In the read command process, the confirmation of whether a failure has occurred in the user data or not is performed in the Step S95 ((12) of FIG. 12) of FIG. 13. Specifically, by comparing the primary hash value of the entry of the primary hash table 420 already secured in the normal state with the primary hash value computed based on the chunk including the user data of the read target, and determining whether these are in agreement or not, whether a failure (data corruption, non-written failure) has occurred or not is confirmed.

And when both of the primary hash values are not in agreement, that is, when a data corruption, etc, has occurred in the chunk of the user data, a user data without a data corruption is acquired by performing the collection read about the chunk including this user data. As a result, when a failure has occurred in the user data, the user data transitions to the normal state, as shown in the arrow 3 of FIG. 14.

As shown in FIG. 14, according to the above-mentioned read command process, even if a failure has occurred in any of the data storing table 430, the primary hash table 420, and the user data, it is possible to make it a normal state.

FIG. 15 is a karnaugh map about the various data and tables in the write command process. In addition, O in the figure shows normal and x shows that a failure has occurred. Moreover, there is a portion to display “user” for the user data, “storing” for the data storing table, and “primary” for the primary hash table as abbreviated.

In the write command process, the confirmation of whether a failure has occurred in the entry of the primary hash table 420 is performed in the Step S19 ((9) of FIG. 4) of FIG. 8. Specifically, by comparing the secondary hash value specifically computed based on the primary hash value of the entry of the primary hash table 420 in (8) of FIG. 4 with the secondary hash value computed from the chunk of the write target data in (4) of FIG. 4, and determining whether these are in agreement or not, whether a failure has occurred in the entry of the primary hash table 420 or not is confirmed.

And when both secondary hash values are not in agreement, that is, when a data corruption may have occurred in the entry of the primary hash table 420, an entry without a data corruption is acquired by performing the collection read about this entry. As a result, when a failure has occurred in the entry of the primary hash table 420, the entry of the primary hash table 420 transitions to the normal state, as shown in the arrow 4 of FIG. 15.

Since it is necessary in write command process to update the referenced number of the primary hash table 420 according to the update of a physical chunk number, it is necessary to secure consistency of the entry of the data storing table 430. The confirmation of whether a failure has occurred in the entry of this data storing table 430 or not is performed in the Step S26 ((15) of FIG. 12) of FIG. 8. Specifically, by comparing the data storing address of the entry of the data storing table 430 acquired based on the physical chunk number corresponding to the write target data with the data storing address of the entry of the primary hash table 420 acquired based on the physical chunk number corresponding to the write target data, and determining whether they are in agreement or not, whether a failure (data corruption) has occurred or not is confirmed.

And when the data storing addresses are not in agreement, that is, when a data corruption may have occurred in the entry of the data storing table 430, an entry without data corruption is acquired by performing the collection read about this entry. As a result, when a failure has occurred on the data storing table 430, the entry of the data storing table 430 transitions to the normal state, as shown in the arrow 5 of FIG. 15

In the write command process, the confirmation of whether a failure has occurred in the user data or not is performed in the Step S24 ((13) of FIG. 4) of FIG. 8. Specifically, by comparing the primary hash value of the entry of the primary hash table 420 already secured in the normal state with the primary hash value computed based on the chunk including the read user, and determining whether these are in agreement or not, whether a failure has occurred or not is confirmed.

And when both primary hash values are not in agreement, that is, when a data corruption has occurred in the chunk of the user data, user data without a data corruption is acquired by performing the collection read about the chunk including this user data. As a result, when a failure has occurred in the user data, the user data transitions to the normal state, as shown in the arrow 6 of FIG. 15.

As shown in FIG. 15, according to the above-mentioned write command process, even if a failure has occurred in any of the data storing table 430, the primary hash table 420, and the user data, it is possible to make it a normal state.

FIG. 16 is a diagram for showing the data structure of the primary hash table entry according to the embodiment 1.

In Example 1, by the secondary hash table 410 and the primary hash table 420 as shown in FIG. 16, the multiple entries of the primary hash tables 420 which have primary hash values corresponding to the same secondary hash value are managed as a link list which coupled them in series. In addition, in this example, there may be multiple link lists corresponding to the same secondary hash value.

In Example 1, entries of the primary hash table 420 referred to one time write command process are entries surrounded by the dashed line of FIG. 16, that is, all the primary hash table entries belonging to the link list corresponding to secondary hash value (arrival data) of the process target.

If it is made to carry out staging of the entry of the primary hash table 420 stored in LDEV313 to the cache memory 119A each time when referring to each entry by write command process, the overhead by the process for it becomes too large.

Then, in Example 1, by assigning the entries of the primary hash table 420 which store the primary hash value which becomes the same secondary hash value, to the same physical chunk or physically a near physical chunk, the number of times of staging of entries referred to by the write command process is reduced.

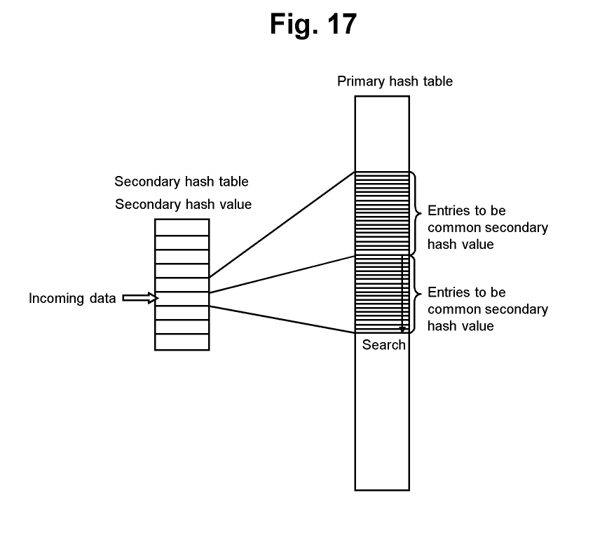

FIG. 17 is a diagram showing the physical storing state of the primary hash table entries according to Example 1.

In Example 1, the processor is made to store multiple entries which become the same secondary hash value in the same physical chunk as shown in FIG. 17. Moreover, the processor is made to store entries which become near secondary hash value in the adjacent physical chunks.

In Example 1, as shown in FIG. 17, in order to store each entry of the primary hash table 420, the processor, for example, according to the rule of (a) through (d) shown below, a physical chunk number of the physical chunk which stores the entry of the primary hash table 420 corresponding to the user data stored newly is assigned.

(a) Let the higher several bytes (for example, 2 bytes) of the physical chunk number be a secondary hash value of user data stored newly.
(b) Let the next several bits (for example, 18 bits) of the higher several bites of (a) be the lower several bits of the primary hash value. Thus, by including the primary hash value in a part of the physical chunk number, the entries which are the same primary hash value can be consolidated to the same physical chunk or a near physical chunk.
(c) When it becomes impossible to store entries in one physical chunk, to store, use the lowest several bits (for example, 4 bits) by adding sequentially from 0.
(d) When all the physical chunks in which (a) and (b) are common are used, look for other physical chunks.

Next, the example at the time of assigning a physical chunk number according to the above-mentioned rule is explained.

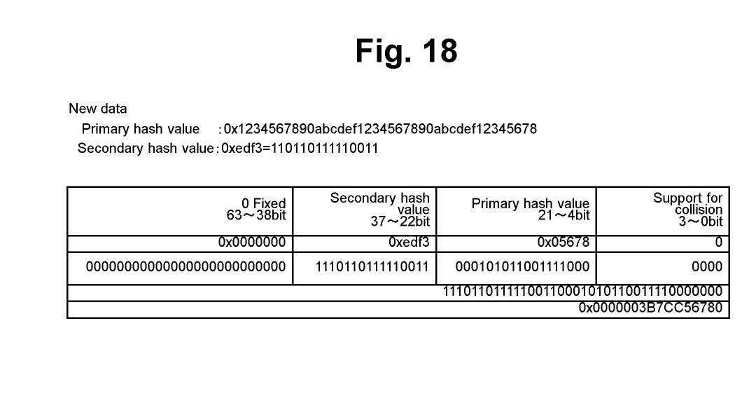

FIG. 18 is a diagram explaining assignment of the physical chunk number of the physical chunk which stores a primary hash table entry. FIG. 18 shows the primary hash value and the secondary hash value of the user data to be stored newly, and the physical chunk number assigned to the entry of the primary hash table 420 in that case.

Here, when a physical chunk number is set to 8 Bytes and the number of the physical chunks is made into 1.25×10¹¹, it is 37 bits to actually be used as an index by the physical chunk number. Therefore, 0 is stored in 63-38 bits of the physical chunk number. The secondary hash value is stored in 37-22 bits of the physical chunk number. The lowest 18 bites of the primary hash value are stored in 21-4 bits of the physical chunk number. The value which shows any of the physical chunk prepared in order to store the entry corresponding to the user data in which the lowest 18 bits of the secondary hash value and the primary hash value are common is stored in 3-0 bit of the physical chunk number. In Example 1, for example, 16 physical chunks are prepared, and when it becomes impossible to store an entry in the physical chunk corresponding to 0, it is used so that it may be considered as the physical chunk of 1. Therefore, the entries corresponding to the user data being the same hash value and in which lowest 18 bits of the primary hash value are common can be consolidated and stored into 16 continuous physical chunks.

For example, when the new data is the primary hash value which is shown in FIG. 18 and the secondary hash value which is shown in FIG. 18, the entry of the primary hash table 420 corresponding to this data, for example, is stored in the physical chunk whose physical chunk number is “0x3B7CC56780”.

In this example, supposing data is equally assigned to all the secondary hash values, entries of the primary hash table 420 corresponding to the primary hash value being the same secondary hash value are storable in the continuous area within 96 MB. Therefore, on the write command process, when searching for the entry of the primary hash table 420, a possibility of having cash hit can be made comparatively high, and the number of times of staging of the required entries of the primary hash table 420 can be reduced.

According to the above-mentioned Example 1, for example, if one sector of a physical storage device is 520 bytes, data of 520 bytes which added LA/LRC of 8 bytes to the user data of 512 bytes is storable in each sector. However, in the physical storage device of SATA, since one sector is 512 bytes, when adding LA/LRC, it is mandatory to store data by the common multiple (for example, 33,280 bytes) unit of 520 bytes and 512 bytes. On the other hand, in Example 1, since a failure of the user data is detectable even if LA/LRC is not stored by adding to the user data, there are no such restrictions and the performance can be improved.

Next, the modification of Example 1 is explained.

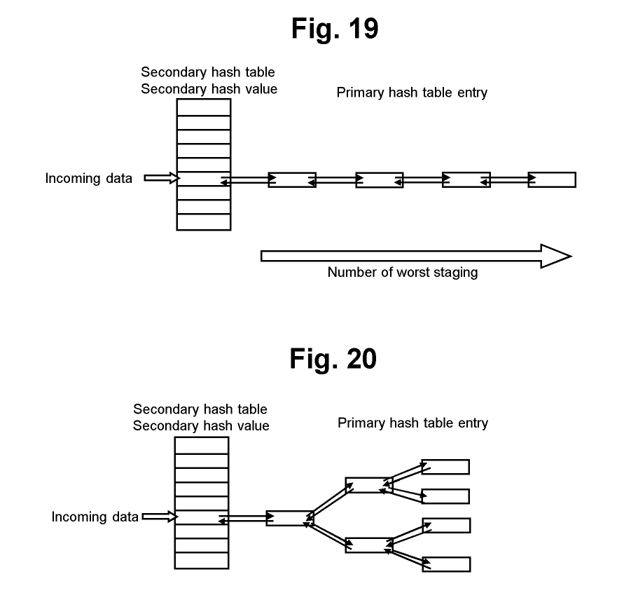

FIG. 19 is a diagram explaining a reference of the primary hash table entry in Example 1.

In Example 1, when searching for the entry of the primary hash table 420 using one secondary hash value, as shown in FIG. 19, it is necessary to follow the link list of the entries corresponding to the secondary hash value, and to search for all the entries. In this case, staging of entries may have to be carried out several times corresponding to the length of the entries.

On the other hand, the data structure of the multiple entries of the primary hash table 420 may be a binary tree (for example, red black tree).

FIG. 20 is a diagram explaining a reference of the primary hash table entry according to the modification.

If the data structure of the multiple entries of the primary hash table 420 is made into a binary tree (for example, red black tree), the length of the link can be shortened as shown in FIG. 20. For example, suppose 1,907,377 primary hash table entries are associated with one secondary hash value, and in case of a list, if 1,907,377 times of search and comparison are not performed, it is not possible to determine whether the primary hash value is the same or not but if in case of a red black tree where the size of the primary hash value is guaranteed, it is possible to complete by the comparison of log₂ 1907377=20.86316 times. Therefore, the search time of the entry of the primary hash table 420 can be shortened. It should be noted that for a same primary hash value, lists having the same primary hash value (primary hash list) are generated and associated with each node in the binary tree. In this case, pointers are generated and managed for the primary hash list separately from those for the binary tree. Using these binary tree and primary hash list, search is performed for deduplication.

### Example 2

Next, the storage system according to Example 2 is explained.

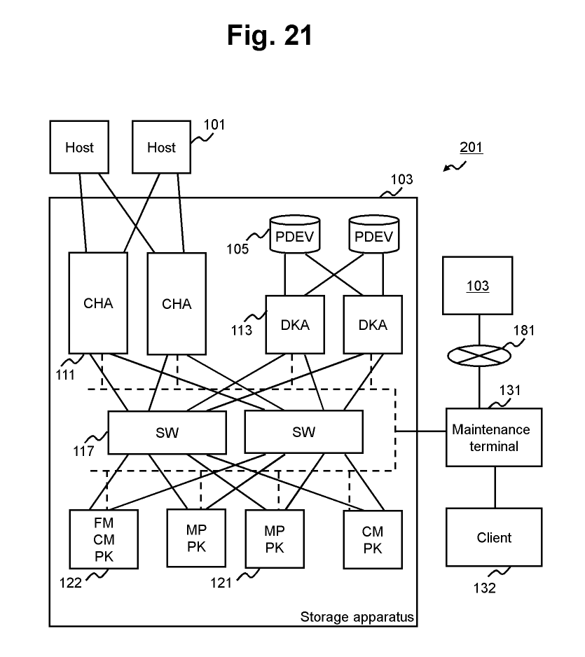

FIG. 21 is a diagram showing the example of a configuration of the storage system according to Example 2. In addition, in FIG. 21, the same mark is attached about the same portion as the storage system according to Example 1 shown in FIG. 2.

The storage system according to Example 2 comprises FMCMPK 122 replacing with the CMPK 119.

The FMCMPK 122 is a storage device (flash memory device) which has one or more flash memories (FM) and a memory controller coupled to one or more flash memories. Typically, a memory controller includes a processor which performs a process. The flash memory, for example is a type of flash memory which is a larger unit (block unit) of data erase than a unit (page unit) of reading and writing of data, and cannot overwrite data. The flash memory is typically a NAND type flash memory. This kind of flash memory consists of multiple blocks, and each block consists of multiple pages. In Example 2, since the flash memory is used, a large capacity is cheaply securable compared with the cache memory configured from the DRAM of Example 1. Therefore, in Example 2, the whole primary hash table 420 is stored in the cache memory. Therefore, since it is not necessary to carry out staging from the PDEV 105, such as HDD, about the primary hash table 420, the process efficiency improves.

Moreover, the processor of the FMCMPK 122 may be made to perform a part of the process (for example, calculation of hash value and deduplication process, etc.) which the processor of the MPPK 121 has performed. In this way, the load of the processor of the MPPK 121 can be reduced and the process efficiency of the whole system can be improved.

In addition, the data storing table 430 may also be stored depending on the capacity of the cache memory of the FMCMPK 122, and in this way, since it is not necessary to carry out staging also about the data storing table 430, the process efficiency improves.

In addition, the unit of deduplication corresponds to the page unit of FM. Since FM can only perform read and write operations on a page-by-page basis, performing deduplication in units of pages is useful for eliminating waste and ensuring efficient use of capacity.

As mentioned above, although some examples are explained, this is the illustration for the explanation of the present invention, and is not the meaning which limits the range of the present invention only to these examples. That is, the present invention can be carried out with other various forms.

### REFERENCE SIGNS LIST

103 Storage apparatus
105 PDEV
119A Cache memory
410 Secondary hash table
420 Primary hash table
430 Data storing table

1. A storage apparatus, comprising:
a first storage device in which a user data is stored, and
a second storage device in which a management information including a primary hash value corresponding to a data management unit including the user data is stored for every data management unit; and
a controller coupled to the first and the second storage devices wherein the controller is configured to,
(A) receive a read request of a read target user data from the upper level apparatus, and acquire the primary hash value of a first management unit which is a data management unit including the read target user data from the second storage device,
(B) read data of the first management unit from the first storage device,
(C) compute a primary hash value based on the data of the first management unit,
(D) determine whether the primary hash value in (A) and the primary hash value in (C) are in agreement or not, and
(E) send the read target user data included in the first management unit to the upper level apparatus when the primary hash value in (A) and the primary hash value in (C) are in agreement.

2. A storage apparatus according to claim 1, wherein the controller is configured to,
(a) receive a write request of a write target user data,
(b) compute a primary hash value of a second management unit that is the data management unit including the write target user data, and
(c) store the management information including the computed primary hash value in the second storage device for the second management unit.

3. A storage apparatus according to claim 2, wherein
a process in the (c) includes,
searching for the data management unit which is the primary hash value of the same value as the computed primary hash value from the second storage device,
determining whether a data of the searched data management unit having the same primary hash value and a data of the data management unit including the write target user data are in agreement or not, storing a logical number of the second management unit and a management information associated with a physical number and a storing destination address of the data management unit including agreed data in the second storage device for the second management unit, when the data of the searched data management unit having the same primary hash value and the data of the data management unit including the write target user data are in agreement.

4. A storage apparatus according to claim 3, further comprising:
a cache memory which stores temporarily the user data which is read from the first storage device, or is written in the first storage device, wherein
the cache memory is configured to store secondary hash value management information, and
in the secondary hash value management information, a secondary hash value which data length is shorter than the primary hash value, and is computed from the primary hash value, is associated with one or more primary hash value by which the secondary hash value is computed,
a process in (c) includes,
computing a secondary hash value of the write target user data, specifying a primary hash value which becomes the secondary hash value from the secondary hash value management information based on the secondary hash value, and
searching for a data management unit in which the primary hash value of same value is computed out of the specified primary hash values.

5. A storage apparatus according to claim 4, wherein the management information includes plurality of management elements which manages the primary hash value of the data management unit of the user data, respectively,
the controller is configured to store multiple management elements which manage primary hash value by which the same secondary hash value is computed in the same or physically near data management unit.

6. A storage apparatus according to claim 5, wherein
the controller is configured to assign a physical number of a data management unit which stores the management element based on the primary hash value and the secondary hash value of user data corresponding to the management element.

7. A storage apparatus according to claim 4, wherein the controller is configured to manage the multiple management units which manage multiple primary hash values of which secondary hash values become the same by a binary tree.

8. A storage apparatus according to claim 1, wherein
the first storage device is a first storage device group which is a RAID (Redundant Array of Independent (or Inexpensive) Disks) group consisted of multiple storage devices,
the controller is configured to,
(F) restore the read target user data from the first storage device group, and send the read target user data to the upper level apparatus, when the primary hash value acquired from the management information and the computed primary hash value are not in agreement.

9. A storage apparatus according to claim 1, wherein
the management information is stored in a second storage device group that is a RAID (Redundant Array of Independent (or Inexpensive) Disks) group which consisted of multiple storage devices,
the management information includes,
primary hash information associated with a physical number of the data management unit including the user data, the primary hash value of the user data and, the storing destination address at the first storage device of the user data, and
a storing information associated with which a logical number of the data management unit including the user data, a physical number of the data management unit, and the storing destination address of the user data,
the controller is configured to,
(G) specify the logical number of the data management unit including the user data based on the read request,
(H) specify the physical number and storing destination address corresponding to the logical number based on the storing information,
(I) specify the storing destination address from the primary hash information based on the specified physical number,
(J) determine whether the storing destination address specified in (H) and the storing destination address specified in (I) are in agreement or not,
(K) restore the primary hash information corresponding to the user data from the second storage device group, when the storing destination addresses are not in agreement in (J), and
in (B), read the data of the data management unit including the read target user data based on the storing destination address of the primary hash information restored in (K).

10. A storage apparatus according to claim 9, wherein
the controller is configured to,
(L) specify a logical number of the data management unit including the user data based on the read request,
(M) specify a physical number and storing destination address corresponding to the logical number from the storing information,
(N) specify a storing destination address from the primary hash information based on the specified physical number,
(O) determine whether the storing destination address specified in (M) and the storing destination address specified in (N) are in agreement with each other or not,
(P) restore the storing information corresponding to the user data from the second storage device when the storing destination addresses are not in agreement in (O), and
in (H), specify the physical number and the storing destination address corresponding to the logical number based on the storing information restored in (P).

11. A storage apparatus according to claim 1, wherein
the second storage device is a flash memory device, and
the flash memory device is configured to store the whole information about the primary hash value.

12. A storage apparatus according to claim 11, wherein
the flash memory device is configured to perform at least a part of the process of the controller.

13. A data management method, comprising;
(A) receiving a read request of read target user data from a upper level apparatus, acquiring a primary hash value of a first management unit which is a data management unit including the read target user data from a second storage device in which a management information including a primary hash value corresponding to the data management unit including a user data is stored for every data management unit,
(B) reading data of the first management unit from a first storage device in which the user data is stored,
(C) computing a primary hash value based on the data of the first management unit,
(D) determining whether the primary hash value in (A) and the primary hash value in (C) are in agreement or not, and
(E) sending the read target user data included in the first management unit to the upper level apparatus when the primary hash value in (A) and the primary hash value in (C) are in agreement.

14. A data management method according to claim 13, further comprising;
(a) receiving a write request of write target user data,
(b) computing a primary hash value of a second management unit that is a data management unit including the write target user data, and
(c) storing the management information including the computed primary hash value in the second storage device for the data management unit.

15. A data management method according to claim 14, wherein
a process in (c) comprising,
searching for the data management unit which is the primary hash value of the same value as the computed primary hash value from the second storage device,
determining whether data of the same data management unit having the searched primary hash value and data of the data management unit including the write target user data are in agreement or not, and
storing a logical number of the second management unit and the management information associated with a physical number and a storing destination address of the data management unit which includes agreeable data, in the second storage device for the second management unit, when the data of the searched data management unit having the same primary hash value and the data of the data management unit including the write target user data are in agreement.
